(19) United States
(12) Patent Application Publication
(10) Pub. No.: US 2023/0265789 A1
(43) Pub. Date: Aug. 24, 2023

(54) POWER SYSTEMS HAVING IMPROVED AIRFLOW AND DIVERSION OF FLUID INGRESS

(71) Applicant: Illinois Tool Works Inc., Glenview, IL (US)

(72) Inventors: Keith Harold Hamm, Oshkosh, WI (US); David Radtke, New London, WI (US)

(21) Appl. No.: 17/679,946

(22) Filed: Feb. 24, 2022

(51) Int. Cl. F02B 63/04; F01P 1/06; F02B 63/06; B23K 9/10

(52) U.S. Cl. CPC F02B 63/044; F01P 1/06; F02B 63/06; B23K 9/1043

(57) ABSTRACT

Disclosed example power systems include an enclosure, an engine within the enclosure; and a generator within the enclosure and configured to convert mechanical power from the engine to electrical power. The enclosure includes a first air inlet on a first end of the enclosure, a first air outlet on a top of the enclosure, and a second air inlet on a side of the enclosure to provide a second airflow through the enclosure. The power system further includes an engine fan configured to generate a first airflow from the first air inlet to the first air outlet to cool the engine. The power system includes a diverter located below the first air outlet and configured to direct environmental contaminants away from at least one of the engine or the generator, where the environmental contaminants enter the enclosure through the first air outlet.

### FIELD OF THE DISCLOSURE

This disclosure relates generally to engine-driven power systems and, more particularly, to power systems having improved airflow and diversion of fluid ingress.

### BACKGROUND

Conventionally, engine-driven power systems (e.g., generators, air compressors, and/or welders) are contained within a metal enclosure that provides environmental protection for the equipment and provides a safety, sound, and aesthetic barrier for the operators. Many different types of enclosures have been used for conventional power systems. Conventional enclosures allow air to enter and exit the enclosure to cool the engine and/or generator components.

### SUMMARY

Power systems having a plurality of fan blades extending from an axial end face of a rotor core, substantially as illustrated by and described in connection with at least one of the figures.

### BRIEF DESCRIPTION OF THE DRAWINGS

FIGS. 1A-1D are perspective views an enclosure of an example power system, in accordance with aspects of this disclosure.

FIG. 2 is a block diagram illustrating components within the enclosure of the example power system of FIGS. 1A-1D.

FIG. 3 is a perspective view of the of the power system of FIG. 2 including a diverter, in accordance with aspects of this disclosure.

FIGS. 4A-4B are block diagrams illustrating airflow paths of the power system of FIG. 2, in accordance with aspects of this disclosure.

The figures are not necessarily to scale. Where appropriate, similar or identical reference numbers are used to refer to similar or identical components.

### DETAILED DESCRIPTION

Conventional power systems include components such as an engine, a generator, and an air compressor. Many such conventional power systems include an enclosure to house the components. The enclosure includes various air inlets and air outlets for the circulation of air through the enclosure (e.g., to cool the internal components). In conventional power systems, the enclosure includes air inlets or outlets near the engine and/or the generator. For instance, a conventional power system may include an air outlet directly above (e.g., on a top surface of the enclosure) one or both of the engine or generator.

Although these air outlets are designed to exhaust air external to the enclosure, the air outlets also allow environmental contaminants (e.g., weather-related materials (rain, snow, sleet, hail, etc.), dust, debris, fluids, etc.) into the enclosure. For example, most air outlets are simple vents that are not configured to prevent the ingress of materials into the enclosure. In turn, conventional power systems with an air outlet (or inlet) above the engine and/or the generator may not be adequately protected from the environmental contaminants entering the enclosure through the air outlet (or inlet). In this way, the engine and/or generator may not function properly and/or have a reduced useful life due to the exposure to the environmental contaminants. Additionally, or alternatively, conventional power systems may have undesirable air recirculation, which may result in improper, inefficient, or insufficient cooling of the components of the conventional power system. Moreover, such conventional power systems may be relatively loud (e.g., not have sufficient sound barrier), which may be due at least in part to the proximity of certain air inlets and/or air outlets to the engine.

Disclosed example power systems do not have air outlets or inlets located above the engine and/or generator. As a result, disclosed example power systems reduce or prevent undesired ingress of environmental contaminants into the engine or generator via the air outlets or inlets on a top surface of the enclosure from contacting the engine and/or the generator.

Disclosed example power systems include a diverter positioned below an air outlet or inlet on the top surface of the enclosure of the power system. The diverter directs the environmental contaminants away from internal components of the power system. For example, the diverter may direct the environmental contaminants to an air inlet or outlet for discharge outside of the enclosure and/or to a bottom of the enclosure (e.g., to be drained). In some examples, the diverter at least partially surrounds one or more components (e.g., an air compressor), either alone or in conjunction with other features of the enclosure. Disclosed example configurations protect the engine, generator, compressor, and/or other components from environmental contaminants, increases the useful life of the component, and reduces noise of the power system (e.g., when in operation). Disclosed example power systems may also reduce air recirculation within the enclosure to improve cooling of the power system.

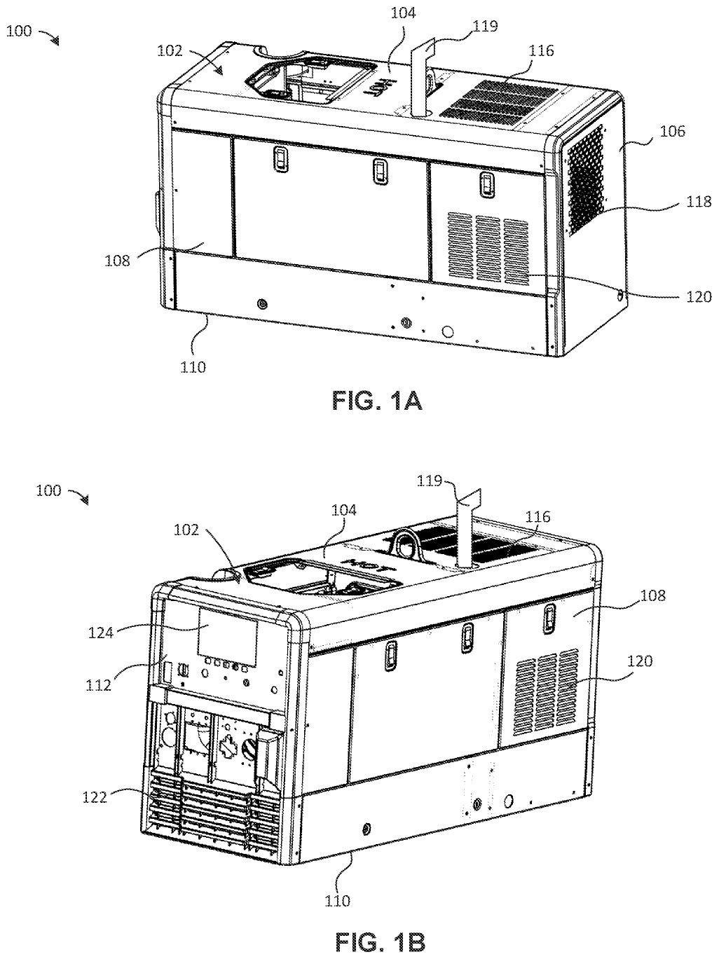

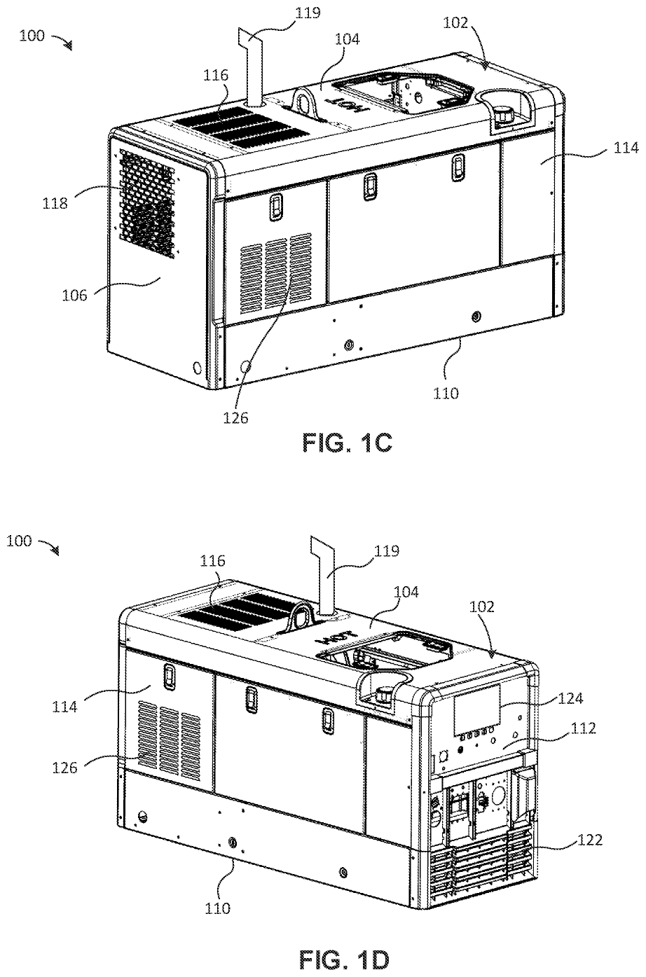

FIGS. 1A-1D are perspective views an enclosure 102 of an example power system 100. The power system 100 may be used for various applications, such as, for example, providing compressed air, generating power, pumping, and/or welding support. The power system 100 includes an enclosure 102. The enclosure 102 protects internal components of the power system 100 from the environment, as well as providing a safety, sound, and aesthetic barrier for an operator using or within range of the power system 100. The enclosure 102 is primarily constructed with sheet metal, and may include multiple panels. One or more of the panels may be removable and/or one or more of the panels may open to permit access.

The enclosure 102 defines various surfaces when the power system 100 is installed in a predetermined orientation (e.g., when the power system 100 is installed in accordance with the power system's 100 intended use). For example, the enclosure 102 defines a top 104, a first end 112, a second end 106, a first side 108, a bottom 110, and a second side 114. The first end 112 may be a front end and the second end 106 may be a rear end. For ease of description and understanding, the first end 112 will be referred to herein as the front end 112 and the second end 106 will be referred to as the rear end 106. In other examples, the first and second ends 112, 106 may be configured differently (e.g., the first end 112 is the rear end and the second end 106 is the front end).

The enclosure 102 includes one or more air inlets and air outlets. The air inlets 120, 122, 126 permit intake of air from an exterior of the enclosure 102 to an interior of the enclosure 102. The enclosure 102 may have any suitable number of air inlets. In some examples, the enclosure 102 includes a first air inlet 120, a second air inlet 122, and a third air inlet 126. In other examples, the enclosure 102 may include fewer than three air inlets or more than three air inlets. In some examples, one or more of the air inlets 120, 122, 126 may be on different surfaces of the enclosure. For example, the power system 100 of FIGS. 1A-1D has the first air inlet 120 on the first side 108 of the enclosure 102, the second air inlet 122 on the front end 112 of the enclosure 102, and the third air inlet 126 on the second side 114 of the enclosure 102. Moreover, in some examples, the first air inlet 120 and/or the third air inlet 126 may be closer to the rear end 106 than the front end 112 along the first or second side 108, 114, respectively. In such examples, the first and third air inlets 120, 126 may be further away from a generator and an engine within the enclosure 102 (as compared to conventional power systems). In turn, environmental contaminants may be less likely to contact the engine and/or the generator, interfere with operation of the power system 100, or decrease the useful life of the power system 100.

In the example of FIGS. 1A-1D, the enclosure 102 further includes air outlets to direct air external to the enclosure 102. For example, the enclosure 102 includes a first air outlet 116 and a second air outlet 118. In some examples, the first air outlet 116 and the second air outlet 118 are on different surfaces of the enclosure 102. For instance, the first air outlet 116 is on the top 104 of the enclosure 102 and the second air outlet 118 is on the rear end 106 of the enclosure 102. As discussed in more detail below, the enclosure 102 defines one or more air routing paths (e.g., between one or more air inlets 120, 122, 126 and one or more air outlets 116, 118, through or around one or more internal components of the power system 100, etc.).

In some examples, the first air outlet 116 may be closer to the rear end 106 than the front end 112 along the top 104 of the enclosure 102. In this way, and as will be described in more detail below, the first air outlet 116 is not directly above the generator or the engine. As compared to conventional power systems, the power system 100 disclosed herein with an air outlet on the top surface 104 of the enclosure 102 but not directly above the generator or the engine, may lessen damage or disruption of the operation of the power system 100 from environmental contaminants that enter the enclosure 102 through the first air outlet 116 and may increase the useful life of the power system 100.

The example power system 100 also includes a user interface 124. In the example power system 100 of FIG. 1, the user interface 124 is on the front end 112 of the enclosure 102. The user interface 124 includes an input device configured to receive inputs selecting mode(s) representative of welding-type processes, mode(s) representative of one or more battery charging modes, mode(s) representative of a vehicle load, and/or other modes such as a pneumatic load and/or a hydraulic load. The example user interface 124 may further include indicators. The example user interface 124 may include controls configured to modify welding and/or battery charging parameters, such as a welding voltage setpoint, a welding wire feed speed setpoint, a welding current setpoint, a nominal battery output voltage, a workpiece material thickness, welding wire parameters (e.g., thickness, type, etc.), a DC output current limit, and/or any other parameters.

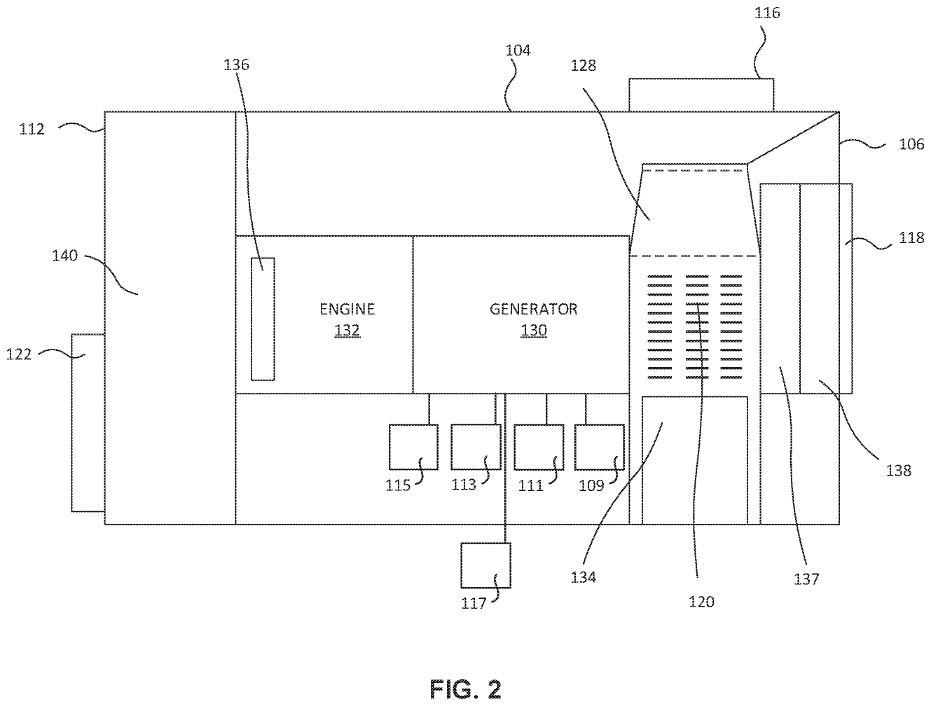

In some examples, control circuitry (e.g., control circuitry 140 of FIG. 2) of the power system 100 automatically determines one or more welding and/or battery charging parameters based on the input device and additional controls, such as by determining a welding voltage and wire feed speed based on a specified material thickness. The control circuitry 140 receives an input selecting one or more of the modes from the user interface 124 (e.g., from the input device). Additionally or alternatively, the control circuitry 140 may receive the input selecting one or more of the modes via a wireless or wired interface to an external device. For example, the control circuitry 140 may be communicatively connected to a computer, a smartphone, tablet computer, and/or any other operator interface device (e.g., via communication circuitry), through which an operator can control the power system 100 (e.g., select any of the modes for operation).

In addition, in some examples, the power system 100 may include a muffler 119. In some such examples, the muffler 119 may function as an exhaust of the engine 132. The muffler 119 extends through the top 104 of the enclosure 102.

FIG. 2 is a block diagram illustrating components within the enclosure 102 of the example power system 100 of FIG. 1. The example power system 100 is an engine-driven power system. The system 100 includes an engine 132 that drives a generator 130 to generate electrical power. The engine 132 may be an internal combustion engine, a diesel engine, a fuel cell, etc. The engine 132 is configured to output mechanical power to drive the generator 130. The engine 132 may receive fuel from a fuel tank.

In some examples, the power system 100 includes one or more power subsystems. For example, the generator 130 may provide the electrical power to welding-type conversion circuitry 109 configured to output welding-type power, an air compressor 134 configured to output pneumatic power, a hydraulic pump 113 configured to output hydraulic power, auxiliary power conversion circuitry 115 configured to output AC power and/or DC power (e.g., DC and/or AC electrical output(s)), and/or any other load device. The example hydraulic pump 113 and the air compressor 134 may be powered by mechanical power from the engine 104 and/or by electrical power from the generator 130.

In some examples, an external power supply subsystem 117 may be coupled (e.g., plugged in, hardwired, etc.) to the power system 100 to convert at least one of the AC power or the DC power from the auxiliary power conversion circuitry 115 and/or the generator 130 to at least one of AC power or DC power, such as to power external devices that have different power requirements. The example external power supply subsystem 117 may also be communicatively coupled to control circuitry 140 of the power system 100 (e.g., wirelessly, via power line communication, via a communication cable, etc.) to enable the control circuitry 140 to control the demand and/or output of the external power supply subsystem 117.

The welding-type conversion circuitry 109 converts output power from the generator 130 (e.g., via the intermediate voltage bus) to welding—type power based on a commanded welding-type output. The welding-type conversion circuitry 109 provides current at a desired voltage to an electrode and a workpiece via output terminals to perform a welding-type operation. The welding-type conversion circuitry 109 may include, for example, a switched mode power supply or an inverter fed from an intermediate voltage bus. The welding-type conversion circuitry 109 may include a direct connection from a power circuit to the output (such as to the weld studs), and/or an indirect connection through power processing circuitry such as filters, converters, transformers, rectifiers, etc.

The auxiliary power conversion circuitry 115 converts output power from the generator 130 (e.g., via the intermediate voltage bus) to AC power (e.g., 120 VAC, 240 VAC, 50 Hz, 60 Hz, etc.) and/or DC power (e.g., 12 VDC, 24 VDC, battery charging power, etc.). The auxiliary power conversion circuitry 115 outputs one or more AC power outputs (e.g., AC outlets or receptacles) and/or one or more DC power outputs (e.g., DC outlets or receptacle). The power system 100 enables multiple ones of the power subsystems (e.g., the hydraulic pump 113, the air compressor 134, the welding-type conversion circuitry 109, the auxiliary power conversion circuitry 115, the external power supply subsystem 117, etc.) to be operated simultaneously.

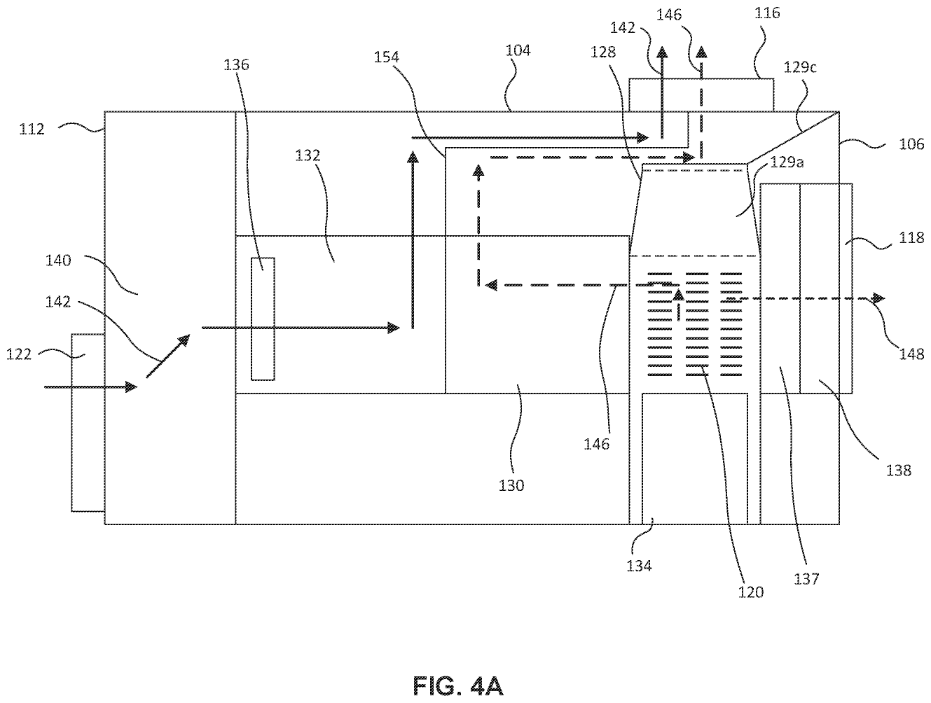

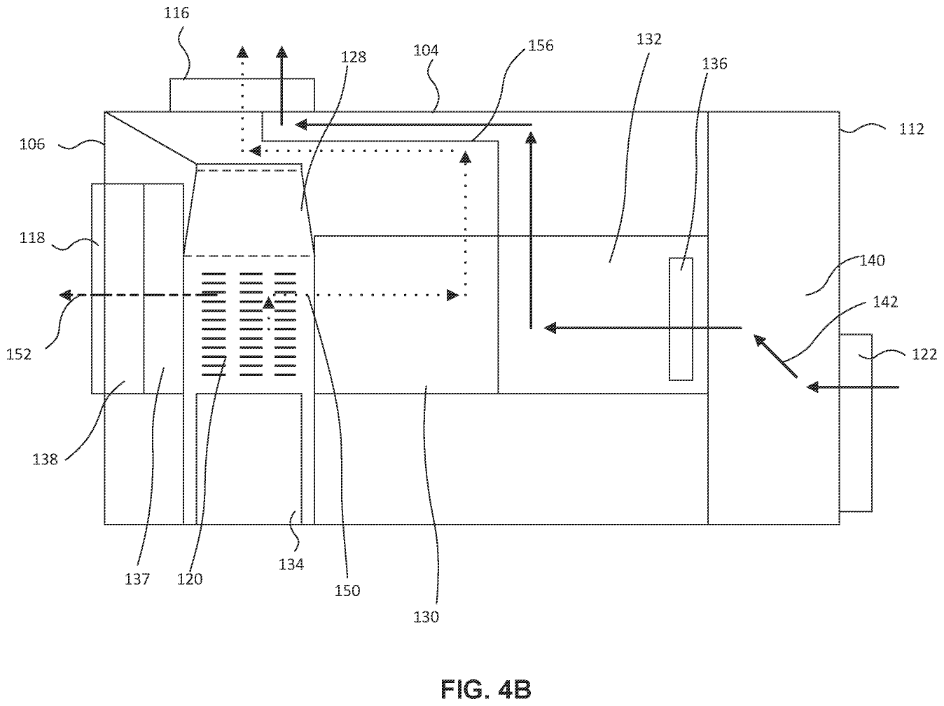

The power system 100 further includes an engine fan 136. The engine fan 136 is driven by rotation of an engine shaft of the engine 132 and/or a rotor shaft of the generator 130. The engine fan 136 pulls air through the enclosure 102. The air can enter and exit the housing 112 at any number of locations, openings, gratings, etc. For example, the air can enter the enclosure through one or more of the air inlets 120, 122, 126 and can exit the enclosure 102 through one of the air outlets 116, 118. The air urged into the enclosure 102 by the engine fan 136 cools one or more internal components of the power system 100. For example, the air may cool one or both of the engine 132 or the generator 130. In some examples, the power system 100 includes a second fan 137 to urge air through the enclosure 102. In such examples, the engine fan 136 may generate a first airflow and the second fan 137 may generate a second airflow. The first and second airflows may be at least partially different from each other (e.g., the air routing paths through which the first and second airflows travel may be at least partially different from each other). Example airflow paths within the enclosure 102 are described in more detail with respect to FIGS. 4A-4B.

The example power system 100 further includes an air compressor 134. The air compressor outputs pneumatic power (e.g., compressed air). In some examples, the air compressor 134 is powered with electrical power from the generator. In other examples, the air compressor 134 is powered with mechanical power from the generator 130. In some examples, the air compressor 134 may use air urged in to the enclosure 102 by the engine fan 136 and/or the second fan 137 as an air intake source.

The power system 100 includes a diverter 128 positioned between the first air outlet 116 on the top 104 of the enclosure 102 and the air compressor 134. In some examples, the diverter 128 at least partially surrounds the air compressor 134. The diverter 128 directs environmental contaminants entering into the enclosure 102 through the first air outlet 116 away from one or more of the internal components of the power system 100 (e.g., away from the engine 132 and/or the generator 130). For example, the diverter 128 may direct the environmental contaminants to a location external to the enclosure 102, via one or both of the first air inlet 120 or the third air inlet 126, direct the environmental contaminants to the bottom of the enclosure 102, or otherwise divert the environmental contaminants away from one or more internal components of the power system 100. In this way, the diverter 128 protects the internal components of the power system 100 from degradation and damage from the environmental contaminants. Moreover, because the air compressor 134 is below the first air outlet 116 rather than the generator 130 or the engine 132 of conventional power systems being below an air outlet on a top surface of an enclosure, the generator 130 and the engine 132 of the disclosed example power system 100 may be more protected from environmental contaminants as compared to conventional power systems.

In some examples, the power system 100 may include a cooler 138 within the enclosure 102. In some such examples, the cooler 138 may be thermally coupled to the compressor 134 and/or another component (e.g., the welding-type power supply) and configured to cool the one or more components that the cooler 138 is coupled to. In some examples, the power system 100 including the cooler 138 may cool the compressor 134 and/or another component more efficiently than power systems not including the cooler 138.

The example power system 100 may include other components not specifically discussed herein, and/or may omit one or more of the components discussed herein. The components of the power system 100 may be arranged within the enclosure 102 in any suitable configuration, in accordance with the aspects of the disclosure.

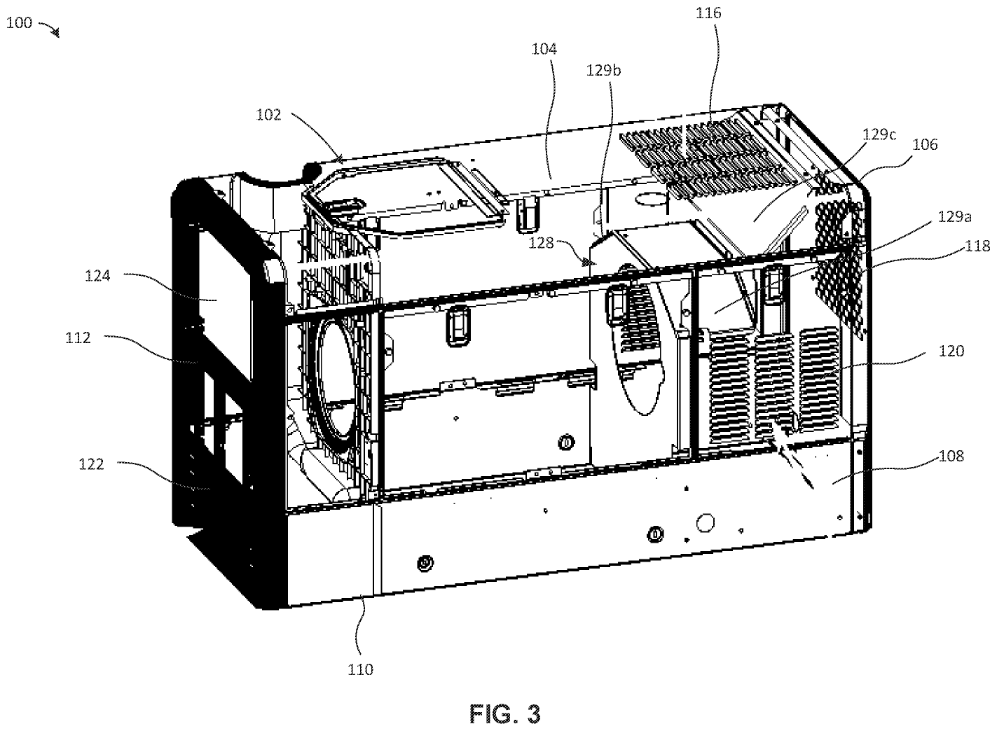

FIG. 3 is a perspective view of the of the power system 100 of FIG. 2 including the diverter 128. The diverter 128 may be in any suitable form. In some examples, the diverter 128 may be made of one or more panels. For example, the diverter 128 may be constructed from one or more panels of sheet metal. In other examples, the diverter 128 may be made of another material.

In some examples, the diverter 128 may have one or more sloped portions. For instance, the diverter 128 illustrated in FIG. 3 has two downward laterally sloped surfaces 129a, 129b, and a downward longitudinally sloped surface 129c. The sloped portions 129a, 129b, 129c direct the environmental contaminants from the first air outlet 116 away from one or more internal components of the power system 100 (e.g., away from the engine 132 and/or the generator 130).

As one example, the sloped portions 129a, 129b, 129c of the diverter 128 may direct the environmental contaminants external to the enclosure 102 via the first and third air inlets 120, 126. Thus, environmental contaminants may enter the enclosure 102 via the first air outlet 116 and travel along the diverter 128 (e.g., down the sloped portions 129a, 129b toward the first and third air inlets 120, 126) to exit the enclosure 102. In other examples, the diverter 128 may have an alternative sloped configuration than that shown in FIG. 3 and/or the diverter 128 may direct the environmental contaminants somewhere within or external to the enclosure 102 other than the first and third air inlets 120, 126. In yet other examples, in some cases, the diverter 128 may direct the environmental contaminants to only one of the first or the third air inlets 120, 126.

FIGS. 4A-4B are block diagrams illustrating airflow paths through the enclosure 102 of the power system 100 of FIG. 2. FIG. 4A illustrates a first airflow 142, a second airflow 146, and a third airflow 148 through the enclosure 102. FIG. 4B illustrates the first airflow 142, a fourth airflow 150, and a fifth airflow 152. It should be noted that although FIGS. 4A-4B illustrate five example airflows 142-152 through the enclosure 102, other examples may include additional or alternative airflows, omit one or more of the illustrated airflows, and/or combine one or more of illustrated airflows.

The first airflow 142 moves through the enclosure 102 from the second air inlet 122 to the first air outlet 116. The first airflow 142 is urged through the engine 132 to cool the engine 132 and is released external to the enclosure 102 through the first air outlet 116. The engine fan 136 generates the first airflow 142 by, for example, pulling air into the enclosure 102 through the second air inlet 122, urges the air into the engine 132, and urges the air out of the enclosure 102 through the first air outlet 116.

The second airflow 146 moves air from outside the enclosure 102 into the enclosure 102 through the first air inlet 120 on the first side 108 of the enclosure 102. In some examples, the second airflow 146 is urged through the generator 130 and released external to the enclosure 102 via the first air outlet 116. Additionally, or alternatively, the second airflow 146 may go through the air compressor 134. The second airflow 146 may cool one or both of the generator 130 or the air compressor 134 and/or may be compressed by the air compressor 134. In some examples, the second fan 137 urges the second airflow 146 through the enclosure 102. The fourth airflow 150 may be substantially the same as the second airflow 146 except that the air inlet for the fourth airflow 150 is the third air inlet 126 on the second side 114 of the enclosure 102 rather than the first air inlet 120.

The third airflow 148 moves air from the first air inlet 120 through the second air outlet 118. The third airflow 148 may be urged through the air compressor 134 to cool the air compressor 134 or be compressed by the air compressor 134. The third airflow 148 may also be urged through the cooler 138. In some examples, the second fan 137 urges the third airflow 148 through the enclosure 102. The fifth airflow 152 may be substantially the same as the third airflow 148 except that the air inlet for the fifth airflow 152 is the third air inlet 126 on the second side 114 of the enclosure 102 rather than the first air inlet 120.

Although the first, second, third, fourth, and fifth airflows 142, 146, 148, 150, 152 are described as separate airflows, in some examples, one or more of the first, second, third, fourth, and fifth airflows 142, 146, 148, 150, 152 may be combined into a single airflow. For example, the second and third airflows 146, 148 may be combined such that a single airflow directs air into the enclosure 102 from the first air inlet 120 and directs at least some air out of the enclosure 102 through the first air outlet 116 and at least some air out of the enclosure 102 through the second air outlet 118. In other examples, other airflows of the first, second, third, fourth, and fifth airflows 142, 146, 148, 150, 152 may be combined into single airflow paths.

In some examples, the power system 100 may include one or more separation barriers 154, 156 to separate one or more airflows from another one or more airflows. For example, the power system 100 may include a separation barrier to separate the first airflow 142 from the second and/or fourth airflow 146, 150 and/or to separate the second and/or fourth airflow 146, 150 from the third and/or fifth airflow 148, 152. In the example of FIG. 4A, the separation barrier 154 separates the first airflow 142 from the second airflow 146. In the example of FIG. 4B, the separation barrier 156 separates the first airflow 142 from the fourth airflow 150. In other examples, a separation barrier may be used to separate additional or alternative one or more airflows.

Additionally, or alternatively, in some examples the diverter 128 and the separation barrier 154 may be the same structure (e.g., to both divert environmental contaminants and separate one or more airflows). For example, in some cases the separation barrier 154 may include at least the diverter 128. In this way, the separation barrier 154 may include at least the sloped portions 129a, 129b, 129c of the diverter 128. In other examples, the diverter 128 and the separation barrier 154 may be different structures. Regardless of whether the separation barrier 154 includes the diverter 128 or if the separation barrier 154 and the diverter 128 are separate structures, the separation barrier 154 and/or the diverter 128 may be made of sheet metal. In some examples, the separation barrier 154 and/or the diverter 128 may include multiple panels of sheet metal. In other examples, the separation barrier 154 and/or the diverter 128 may include a single panel of sheet metal. In yet other examples, the separation barrier 154 and/or the diverter 128 may be made a material other than sheet metal.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A power system comprising:
an enclosure;
an engine within the enclosure;
a generator within the enclosure and configured to convert mechanical power from the engine to electrical power;
a first air inlet on a first end of the enclosure;
a first air outlet on a top of the enclosure;
an engine fan configured to generate a first airflow from the first air inlet to the first air outlet to cool the engine;
a second air inlet on a side of the enclosure to provide a second airflow through the enclosure; and
a diverter located below the first air outlet and configured to direct environmental contaminants away from at least one of the engine or the generator, wherein the environmental contaminants enter the enclosure through the first air outlet.

2. The power system as defined in claim 1, wherein the power system further comprises at least one of:
an air compressor coupled to at least one of the electrical power from the generator or the mechanical power from the engine and configured to output compressed air;
welding-type conversion circuitry configured to convert electrical power from the generator to welding-type power;
a hydraulic pump configured to generate hydraulic pressure from at least one of the electrical power from the generator or the mechanical power from the engine; or
auxiliary power conversion circuitry configured to convert the electrical power from the generator to at least one of AC output power or DC output power, wherein the diverter is configured to direct the environmental contaminants away from at least one of the air compressor, welding-type conversion circuitry, the hydraulic pump, or the auxiliary power conversion circuitry.

3. The power system as defined in claim 2, wherein the power system comprises the air compressor, wherein the diverter is positioned between the first air outlet and the air compressor.

4. The power system as defined in claim 3, wherein the diverter at least partially surrounds the air compressor.

5. The power system as defined in claim 1, wherein the first end of the enclosure comprises a front end of the enclosure.

6. The power system as defined in claim 5, further comprising a user interface having at least one user input device on the front end of the enclosure.

7. The power system as defined in claim 1, further comprising a muffler having an exhaust extending through the top of the enclosure.

8. The power system as defined in claim 1, wherein the second airflow directs air external to the enclosure through the first air outlet.

9. The power system as defined in claim 1, further comprising a second air outlet on a rear end of the enclosure.

10. The power system as defined in claim 9, wherein the second airflow directs air external to the enclosure through at least one of the first air outlet or the second air outlet.

11. The power system as defined in claim 10, further comprising a second fan configured to generate the second airflow to direct the air from the second air inlet to at least one of the first air outlet or second air outlet.

12. The power system as defined in claim 1, further comprising a separation barrier configured to separate the first airflow from the second airflow.

13. A power system comprising:
an enclosure defining a front surface, a rear surface, a top surface, a first side surface, and a second side surface when the power system is installed in a predetermined orientation;
a first air inlet on the enclosure to permit intake of air from an exterior of the enclosure to an interior of the enclosure;
a second air inlet on the enclosure to permit intake of air from an exterior of the enclosure to an interior of the enclosure, wherein the second air inlet is on a different surface of the enclosure than the first air inlet;
a first air outlet on the enclosure to direct the air external to the enclosure, wherein the first air outlet is located closer to the rear surface of the enclosure than the front surface of the enclosure;
a second air outlet on the enclosure to direct air external to the enclosure, wherein the second air outlet is on a different surface of the enclosure than the first air outlet;
a first air routing path defined by the enclosure to direct the air from at least one of the first air inlet or the second air inlet to the first air outlet through at least one of:
an engine within the enclosure, or
a generator within the enclosure, wherein the generator is configured to convert mechanical power from the engine to electrical power;
a second air routing path defined by the enclosure to direct air from the second air inlet to the second air outlet; and
a diverter proximate the first air outlet to divert environmental contaminants away from at least one of the generator or the engine, wherein the environmental contaminants enter the enclosure through the first air outlet.

14. The power system as defined in claim 13, wherein the diverter is configured to direct the environmental contaminants external to the enclosure through the second air inlet.

15. The power system as defined in claim 13, further comprising at least one of:
an air compressor coupled to at least one of the electrical power from the generator or the mechanical power from the engine and configured to output compressed air;
welding-type conversion circuitry configured to convert electrical power from the generator to welding-type power;
a hydraulic pump configured to generate hydraulic pressure from at least one of the electrical power from the generator or the mechanical power from the engine; or
auxiliary power conversion circuitry configured to convert the electrical power from the generator to at least one of AC output power or DC output power, wherein the diverter is configured to direct the environmental contaminants away from at least one of the air compressor, welding-type conversion circuitry, the hydraulic pump, or the auxiliary power conversion circuitry.

16. The power system as defined in claim 15, wherein the diverter is positioned between the first air outlet and the air compressor.

17. The power system as defined in claim 16, wherein the diverter at least partially surrounds the air compressor

18. The power system as defined in claim 13, wherein the first air outlet is on the top surface of the enclosure and the second air outlet is on the rear surface of the enclosure.

19. The power system as defined in claim 13, wherein both the first air routing path and the second air routing path direct at least some air through one or both of the engine or the generator.
